(19) United States
(12) Patent Application Publication
(10) Pub. No.: US 2004/0105950 A1
(43) Pub. Date: Jun. 3, 2004

(54) Composite wood board having an alternating tongue and groove arrangement along a pair of edges

(76) Inventor: John Landus Bennett, Nicholson, GA (US)

Correspondence Address: Carlos Nieves, Esq., J.M. Huber Corporation, 333 Thornall Street, Edison, NJ, 08837-2220, US

(21) Appl. No.: 10/308,649

(22) Filed: Dec. 3, 2002

(51) Int. Cl. B32B 3/00

(52) U.S. Cl. 428/58

(57) ABSTRACT

A rectangular composite wood board includes along each of its long edges an alternating tongue and groove construction, the tongue being insertable into a similarly shaped groove. In one embodiment, each of the short edges of the board is in contact with a groove at one end and a tongue end at the other, and each of the long edges includes an equal number of tongues and grooves. In another embodiment, each of the long edges has a groove at each of its ends and the grooves are equal to or longer than the longitudinal length of a tongue.

### BACKGROUND OF THE INVENTION

The subject invention relates to composite wood boards and, in particular, to boards having compatible tongue and groove arrangements.

Composite wood boards, such as plywood boards or oriented strand boards, are well-known in the construction industry. In fact, such boards are used in the manufacture of inclined roofs. To facilitate making the roofs, board manufacturers sell rectangular boards which are about four feet wide, eight feet long and about ⅜ to ¾ of an inch thick. One of the long edges of each of the boards includes a tongue protruding along the entire edge while the other long edge includes a complementary groove. Therefore, it is possible for the tongue of one board to engage the groove of another. In the manufacture of a roof, this process is repeated many times and the boards are, in addition, secured to the rafters of the building under construction. This construction technique works well but has the disadvantage (relative to roofs made with boards which do not have tongue and groove edges) that boards, which typically weigh sixty-five pounds, have to be manipulated into positions where tongue and grooves engage and manipulating these boards, particularly on an inclined roof, is risky.

### SUMMARY OF THE INVENTION

It is an object of the present invention to provide a rectangular composite board having a tongue and groove arrangements along each of its two long edges, wherein either edge of such a board can engage either of the two long parallel edges of another similarly constructed composite board.

The invention herein may be summarized as a composite wood board having rectangularly disposed edges, each of the long parallel edges including an alternating tongue and groove arrangement. The arrangement permits engagement between the tongues and grooves disposed along one edge of a board and the tongues and grooves disposed on either of the long edges of a similar board. The boards are particularly useful in the home construction industry in the manufacture of roofs and flooring.

### BRIEF DESCRIPTION OF THE DRAWINGS

The above-mentioned and other objects of invention will become apparent by reference to the following description in conjunction with the accompanying drawings, in which:

FIG. 1 is a perspective view of a composite wood board, according to the invention;

FIG. 2 is a plan view of a board, according to the invention, aligned with a plan view of a section of a similar board;

FIG. 3 is a partial plan view of a pair of boards, each according to the invention, aligned for engagement;

FIG. 4 is a partial plan view of a pair of boards, each according to the invention, engaged; and

FIG. 5 is a perspective view of another composite wood board, according to the invention.

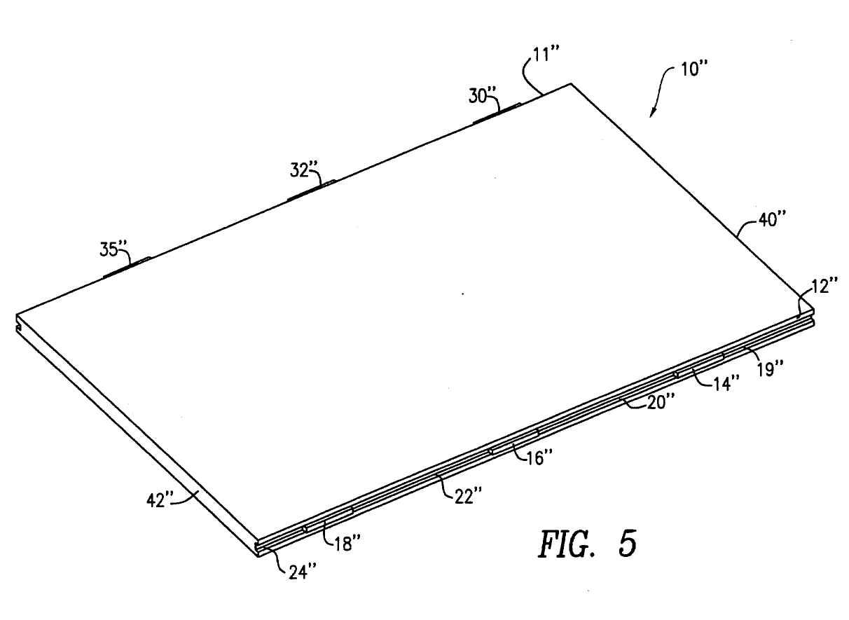

### DESCRIPTION OF A PREFERRED EMBODIMENT

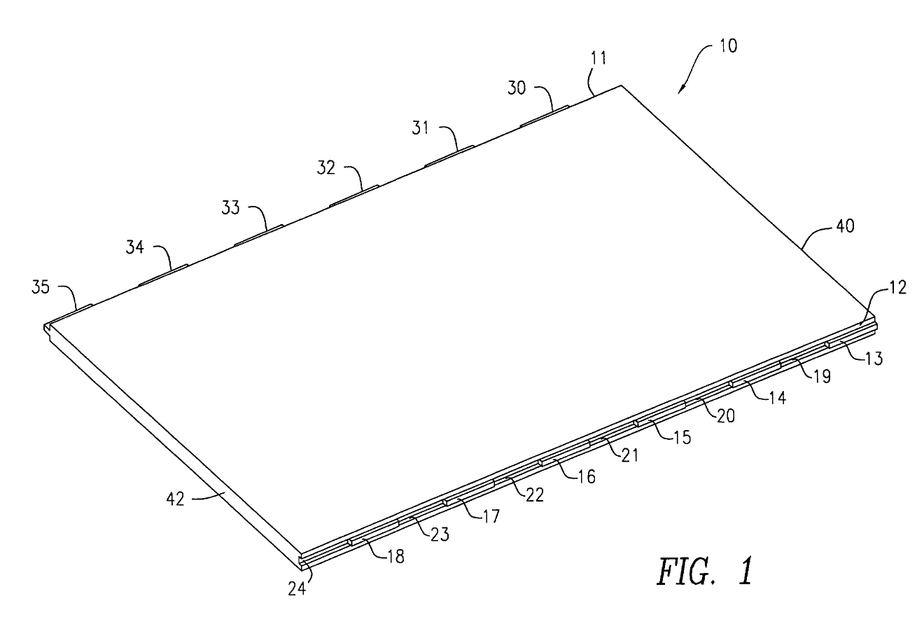

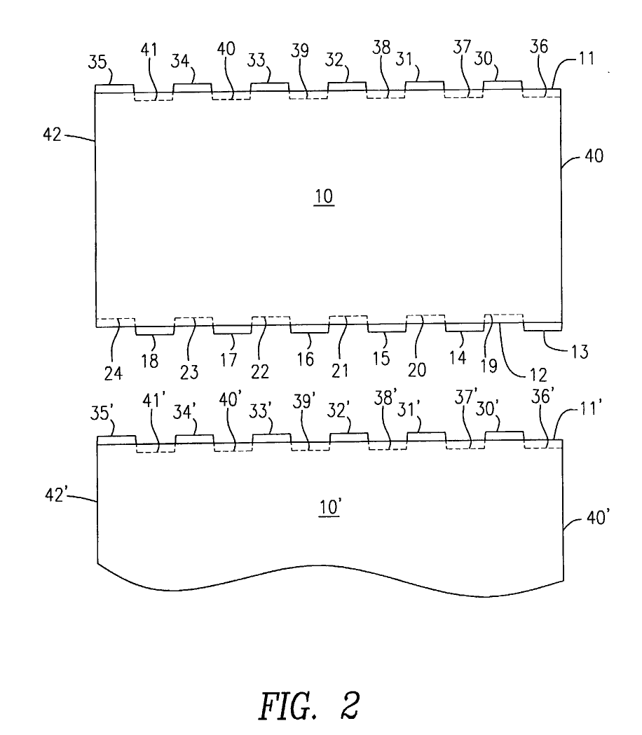

FIG. 1 shows a perspective of a composite wood board 10, according to the invention. The board is generally rectangular, and in this embodiment of the invention is eight feet long by four feet wide. As may be seen in FIGS. 1 and 2, each of the long edges 11 and 12 of board 10 includes an alternating tongue and groove arrangement. Specifically, edge 12 includes perpendicularly extending tongues 13-18 and grooves 19-24. Tongue and groove pairs (13, 19), (14, 20), (15, 21), (16, 22), (17, 23) and (18, 24) are contiguous and of equal length. Given that the length of the board is eight feet, the length of each tongue and groove pairs is sixteen inches. Edge 11 is similarly constructed. It includes tongues 30-35, grooves 36-41 and tongue and groove pairs (35, 41), (34, 40), (33, 39), (32, 38), (31, 37) (30, 36). The short edge 40 of the board 10 is in contact with groove 36 and tongue 13. Similarly, the other short edge 42 of the board is in contact with groove 24 and tongue 35. Thus, tongues and grooves of board 10 are directly opposite each other.

In the present embodiment, each of the edges 11 and 12 includes six tongue and groove pairs. However, the edges can be modified to include more or less pairs.

FIGS. 2, 3 and 4 show a board 10′. This board is the same as board 10 and corresponding parts have been referenced with the same number and a prime notation.

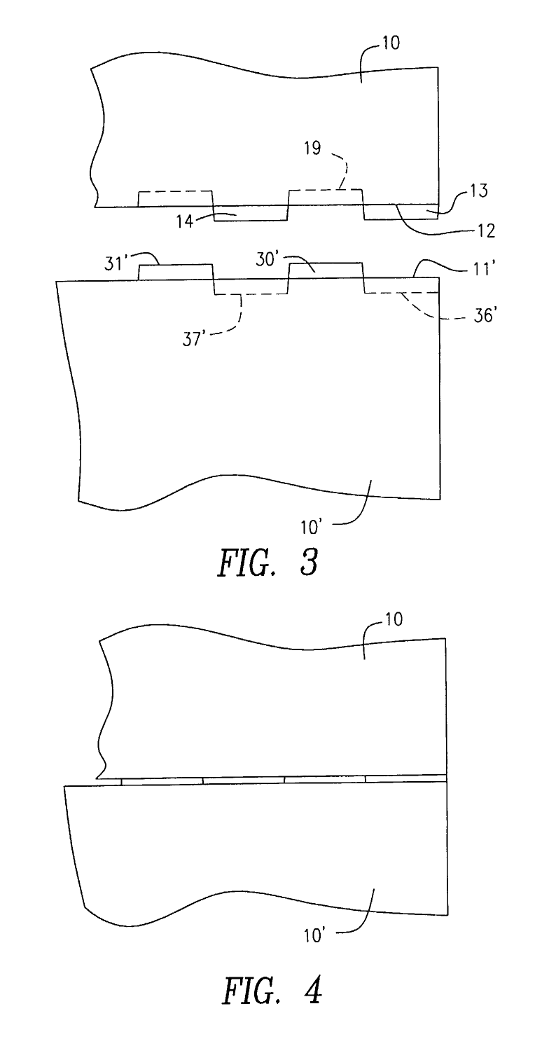

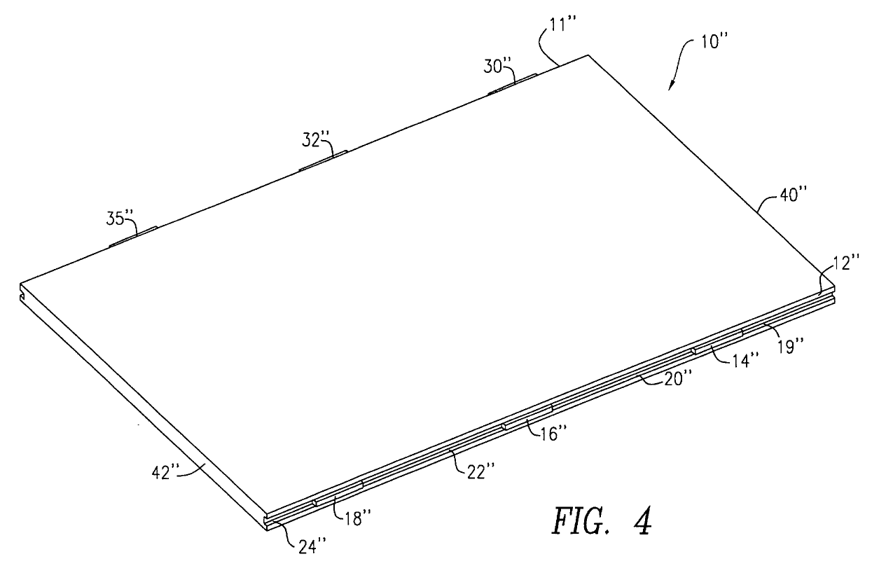

Referring to FIGS. 1 and 3, each of the grooves in board 10 is an elongated slot and each tongue is an elongated extension adapted to snugly fit within such a slot. To facilitate such arrangement, adjacent tongues and grooves are joined by surfaces which give the tongues and grooves a slightly trapezoidal appearance. In making the boards, the tongue is constructed to abut the bottom of an engaged groove before the surfaces of the boards contact, as shown in FIG. 4. Preferably, when boards are in such a position, adjoining surfaces of the tongues and grooves are in abutment to prevent lateral movement between the boards 10 and 10′.

It should be noted that circumstances may exist wherein some lateral movement between engaged boards is desirable. In this case, the tongues can be narrower in the edge direction and the grooves can be longer. An example of this may be a board having six inch tongues and eighteen inch grooves. Such a board 10″ is shown in FIG. 4, In the figure, the same reference numbers used in FIG. 1 and a double prime notation have been used to identify similar structures. Note that FIG. 4 shows a board 10″ which is the same as the board 10 in FIG. 1, except that tongues 13, 15, 17, 30, 33 and 35 have been removed and replaced by a groove.

Referring to FIG. 2, the tongues and grooves along edge 12 can be brought into engagement with the tongues and grooves along edge 11′. Similarly, if board 10 is rotated one hundred and eighty degrees, the tongues and grooves on edge 11 can be brought into engagement with the tongues and grooves along edge 11′. Thus, if the boards are to be used, for example, in the manufacture of a roof, rotation of one board with respect to another in preparation for engagement is reduced. This is very desirable because the boards weigh about sixty-five pounds and moving them about on an inclined roof is risky.

When constructing a roof, the line formed by the intersection of two roofing surfaces often results in the waste of parts of roofing boards. For example, with traditional tongue and groove boards, it is frequently necessary to cut a board along a line to allow the resulting edge to define part of a roof surface intersection. If, for example, all panels are laid with the tongues facing up, the utility of the part of the panel which was cut but not used is not immediately apparent and it may wind up as waste. In contrast, if a board according to the invention is used, it can be cut along a line to provide a section which forms part of one roof and an edge defining the surface intersection. The other board section can be flipped over and used on the other surface with the cut edge in abutment along the intersection, thus resulting in a more efficient use of the boards.

To manufacture a board 10, a tongue may be cut along each of the long edges of a four by eight feet oriented strand board. Thereafter, a cutter may be used to cut grooves on eight inch increments so that the board will have eight inches of tongue and eight inches of groove all the way down both of the long edges of the board.

I claim:

1. A composite wood board comprising:
a first edge,
a second edge parallel to the first edge, the first and second edges having contiguous sections of equal length, each section having a groove and a tongue compatible with the groove.

2. A composite wood board, as defined in claim 1, wherein the length of the first edge is a multiple of the length of a section.

3. A composite wood board, as defined in claim 2, wherein the length of the tongue in each section measured in the longitudinal direction of an edge is less than or equal to the length of the grooves in each section.

4. A composite wood board, as defined in claim 3, wherein the board includes a third edge and a fourth edge parallel to the third edge.

5. A composite wood board, as defined in claim 2, further including a third edge which is substantially perpendicular to the first and second edges; a fourth edge which is substantially perpendicular to the first and second edges; the first edge having the grooves and tongues of the sections alternately disposed with a groove adjacent the third edge and a tongue adjacent the fourth edge; and the fourth edge having the grooves and tongues of the section alternately disposed with a tongue adjacent the third edge and groove adjacent the fourth edge.

6. A composite wood board, as defined in claim 5, wherein the length of the tongue in each section measured in the longitudinal direction of an edge is less than or equal to the longest of the grooves in each section.

7. A composite wood board, as defined in claim 6, wherein the multiple is at least 6.

8. A composite wood board, as defined in claim 6, wherein the distance between the third and fourth edges is substantially eight feet.

9. A composite wood board, as defined in claim 6, wherein the board is an oriented strand board.
